(19) United States
(12) Patent Application Publication
(10) Pub. No.: US 2009/0277653 A1
(43) Pub. Date: Nov. 12, 2009

(54) LIQUID WET CHEMICAL FIRE EXTINGUISHING SPRAY

(75) Inventor: Vincent Mori, Plainfield, IL (US)

Correspondence Address: BRK Brands, Inc., 2381 Executive Center Drive, Boca Raton, FL, 33431, US

(73) Assignee: BRK Brands, Inc, Aurora, IL (US)

(21) Appl. No.: 12/440,551

(22) PCT Filed: Aug. 29, 2007
(86) PCT No.: PCT/US07/19009

§ 371 Date: Mar. 9, 2009

Related U.S. Application Data
(60) Provisional application No. 60/843,866, filed on Sep. 11, 2006.

(51) Int. Cl. A62C 13/00; A62D 1/00; A62D 1/02

(52) U.S. Cl. 169/30; 252/2; 252/3

(57) ABSTRACT

An aerosol fire extinguisher for dispensing a liquid wet chemical fire extinguishing agent, and a composition for the liquid wet chemical fire extinguishing agent, where the liquid wet chemical fire extinguishing agent is rated for class A, B, C and K fires. The fire extinguisher includes a container and a valve assembly affixed to the container A bag is positioned within the container, where the bag includes an output tube connected in fluid communication to the valve assembly. A actuator is connected in fluid communication to the valve assembly opposite the output tube, where the actuator has an elongated output orifice. A liquid wet chemical fire extinguishing agent is disposed within the bag and a propellant is disposed within the container, wherein the bag isolates the liquid wet chemical fire extinguishing agent from the propellant. The configuration of the elongated output orifice expels the liquid wet chemical fire extinguishing agent in a substantially planar pattern onto the fire.

### FIELD OF THE INVENTION

The disclosure relates to an aerosol hand held fire extinguisher, and more particularly, to an aerosol hand held fire extinguisher for dispensing a liquid wet chemical fire extinguishing spray and the composition thereof.

### BACKGROUND OF THE INVENTION

Fires can be categorized in the United States into five basic classes: Class A fires are fires in ordinary combustible material, eg., wood, cloth, paper, rubber, and many plastics; Class B fires are fires in flammable and combustible liquids, gases, and greases; Class C fires are fires that involve energized electrical equipment where the electrical non-conductivity of the extinguishing media is of importance; Class D fires are fires that involve combustible metals; and Class K fires are fires that involve cooking oils or fats. In each of the classes, the formation and continuation of the fire requires three basic elements; heat, fuel, and an oxidizing agent. By removing one of these elements the fire can be extinguished.

Different types of portable fire extinguishers have become useful in extinguishing the different classes of fires. The most common types of portable fire extinguishers are; water, CO₂, and dry chemical, where each of these types has its usefulness on different classes of fires. For Class A fires water and dry chemical fire extinguishers are recommended. For Class B and C fires CO₂ and dry chemical extinguishers are recommended. For Class D fires dry chemical extinguishers are recommended. For Class K fires wet chemical extinguishers are recommended.

However, each of these types of extinguishers has its own disadvantages. For example, you would never use a water extinguisher on a cooking oil, grease or electrical fire. As water is insoluble with cooking oil or grease, the water will cause flare up spreading the oil or grease, the flames and making the fire bigger. Similarly, as water is a good conductor of electricity, the use of this on an electrical fire can be dangerous for the user. Furthermore, water extinguishers tend to be pressurized with oxygen.

CO₂ extinguishers contain carbon dioxide, a non-flammable gas, and are highly pressurized. The pressure is so great that it is not uncommon for bits of dry ice to shoot out the actuator (nozzle).

Dry chemical extinguishers are filled with chemicals that leave a residue. In B:C type dry chemical extinguishers, the residue can be corrosive, difficult to clean and must be cleaned immediately to prevent damage to surrounding materials. In A:B:C type dry chemical extinguishers, the residue can be sticky, difficult to clean and damaging to surrounding materials.

### SUMMARY OF THE INVENTION

The present disclosure recites an aerosol fire extinguisher for dispensing a liquid wet chemical fire extinguishing spray. The fire extinguisher includes a container and a valve assembly affixed to the container. A bag is positioned within the container, where the bag includes an output tube connected in fluid communication to the valve assembly. An actuator (nozzle) is connected in fluid communication to the valve assembly opposite the output tube, where the actuator has an elongated output orifice. A liquid wet chemical fire extinguishing agent is disposed within the bag and a propellant is disposed within the container, wherein the bag isolates the liquid wet chemical fire extinguishing agent from the propellant.

The liquid wet chemical fire extinguishing agent includes the following ingredients:
CH₃CHOHCO₂H (Lactic Acid);
KOH (Potassium Hydroxide); and
H₂O.

The liquid wet chemical fire extinguishing spray can further include: K₂CO₃ (Potassium Carbonate) and KHCO₃ (Potassium Bicarbonate).

In an exemplary embodiment, the liquid wet chemical fire extinguishing agent can include:

| | |
|---|---|
| CH₃CHOHCO₂H (Lactic Acid) | 17-43 vol. % |
| KOH (Potassium Hydroxide) | 18-48 vol. % |
| K₂CO₃ (Potassium Carbonate) | 0-23 vol. % |
| KHCO₃ (Potassium Bicarbonate) | 0-23 vol. % |
| H₂O | Balance of volume |

In a method of using the fire extinguisher to extinguish a fire, the elongated orifice is directed at the fire. The actuator is depressed to open the valve. The liquid wet chemical fire extinguishing agent is expelled onto the fire, where the elongated output orifice expels the agent in a substantially planar pattern.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts a front isometric view of a fire extinguisher including the liquid wet chemical fire extinguishing spray of the present disclosure;

FIG. 2 depicts a front isometric sectional view of the fire extinguisher of FIG. 1;

FIG. 3 depicts a bag of the fire extinguisher of FIG. 1;

FIG. 4 depicts a cross sectional view of a fluid dispensing actuator of the present disclosure;

FIG. 4A depicts a top cross sectional view of the fluid dispensing actuator of FIG. 4;

FIG. 5 depicts a substantially planar spray pattern of the fire extinguisher of FIG. 1; and

FIG. 6 depicts a method of using the fire extinguisher of FIG. 1.

### DETAILED DESCRIPTION OF THE INVENTION

The present disclosure is directed to an aerosol fire extinguisher for dispensing a liquid wet chemical fire extinguishing spray, and a composition for the liquid wet chemical fire extinguishing agent, where the agent is rated for class A, B, C and K fires. The liquid wet chemical fire extinguishing agent is dispensed though an actuator having an elongated output orifice. The configuration of the elongated output orifice expels the liquid wet chemical fire extinguishing agent in a substantially planar pattern onto the fire. Additionally, the actuator dispenses the liquid wet chemical fire extinguishing agent through the elongated output orifice at a reduced particle size, where the reduced particle size is sufficiently small to increase the air gap between particles and decrease or eliminate the electrical conductivity of the dispensed liquid wet chemical fire extinguishing agent in Class C fires.

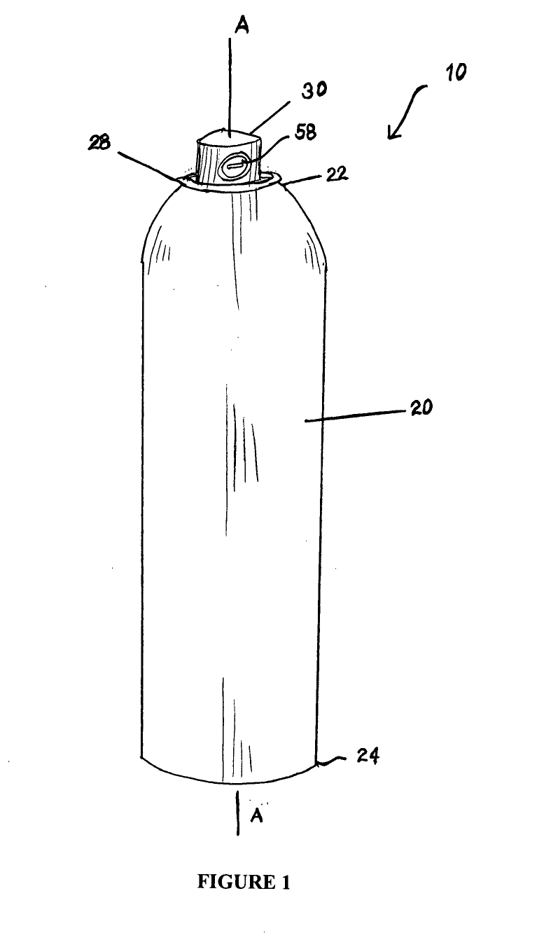

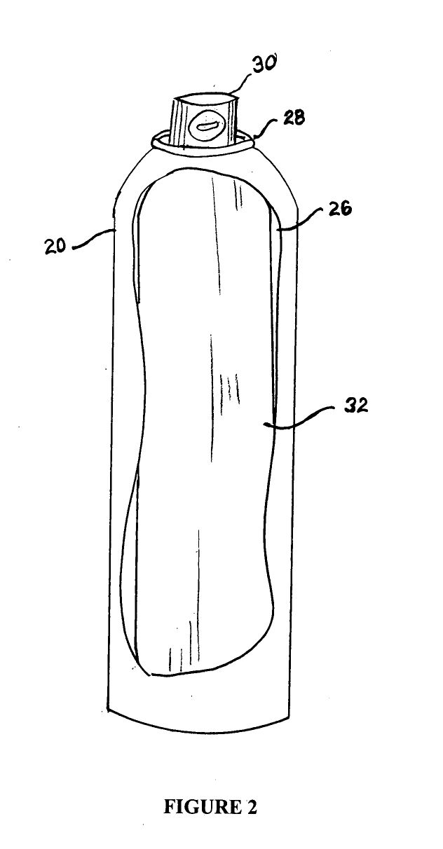

Referring now to the drawing figures in which like reference designators refer to like elements, there is shown in FIGS. 1 and 2 a fire extinguisher 10. The fire extinguisher 10 include a substantially cylindrical container 20 having top and bottom ends 22 and 24, and defining a hollow interior space 26. A valve member 28 is positioned on and affixed to the top end 22 of the container 20. A fluid dispensing actuator (nozzle) 30 is connected to the valve member 28.

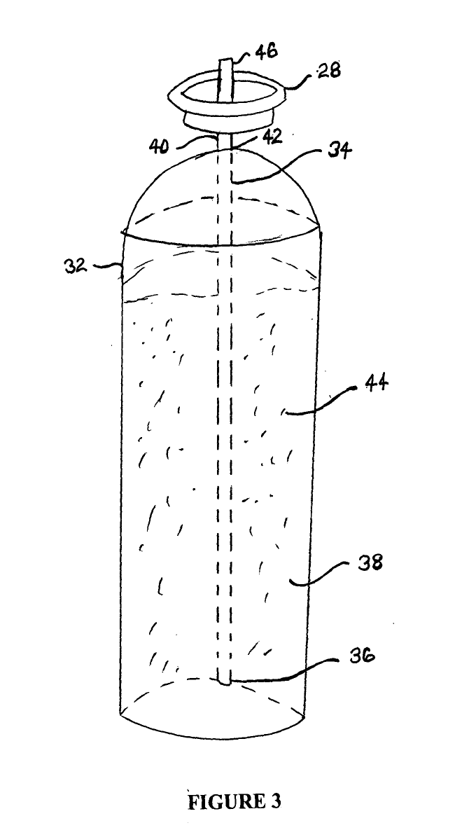

Referring to FIGS. 2 and 3, a bag 32 is positioned within the interior space 26 of the container 20. The bag 32 includes an output tube 34 having a first end 36 positioned within the interior 38 of the bag 32 and a second end extending 40 from a top end 42 of the bag 32. The top end 42 of the bag 32 is sealed about the output tube 34, such that the contents 44 of the bag 32 are isolated from the interior space 26 of the container 20. The second end 40 of the output tube 34 is connected to the valve member 28, such that the valve member 28 is in fluid communication with the contents 44 in the interior 38 of the bag 32.

The bag 32 can be a non-permeable bag, preventing the passing or diffusion of liquids or gases through the bag. Additional exemplary bags 32 are described in U.S. Pat. No. 5,169,037 and U.S. Reissue Patent No. RE35,540, the contents of which are herein incorporated by reference in their entirety.

The valve member 28 includes a downwardly extending stem 46 to which the fluid dispensing actuator 30 is connected. A downward depression of the fluid dispensing actuator 30 depresses the downwardly extending stem 46, opening the valve member 28. In the manner, the contents 44 of the bag 32 are free to flow through the output tube 34, the downwardly extending stem 46, an ultimately through the fluid dispensing actuator 30. Since the operations of the valve member 28 are well known in the prior art, they will not be described herein.

The hollow interior space 26 of the container 20 is charged with a pressurized gas (propellant) 48, such that the bag 32 and contents 44 are maintained under pressure. In this manner, a depression of fluid dispensing actuator 30 opens the valve member 28, resulting in a release of the contents 44 from bag 32 through the fluid dispensing actuator 30. Furthermore, as the bag 32 is sealed from the interior space 26 of the container 22, no propellant 48 is released from the interior space 26 of the container 20 with the contents 44 of the bag 32.

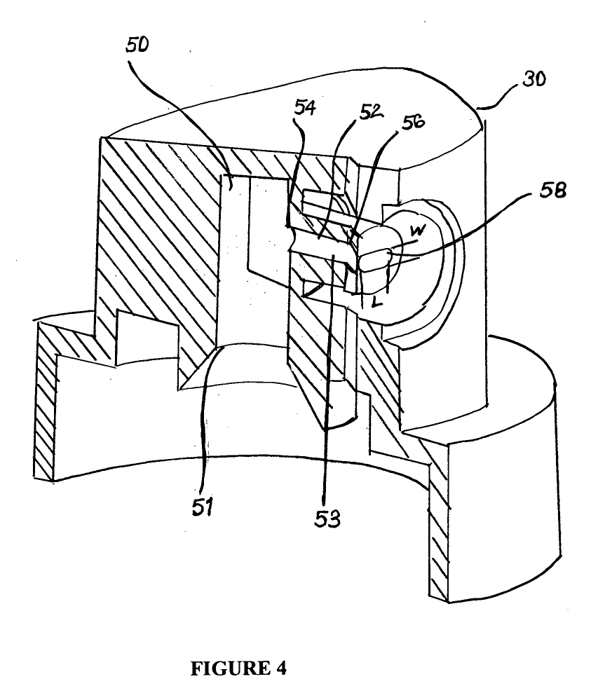

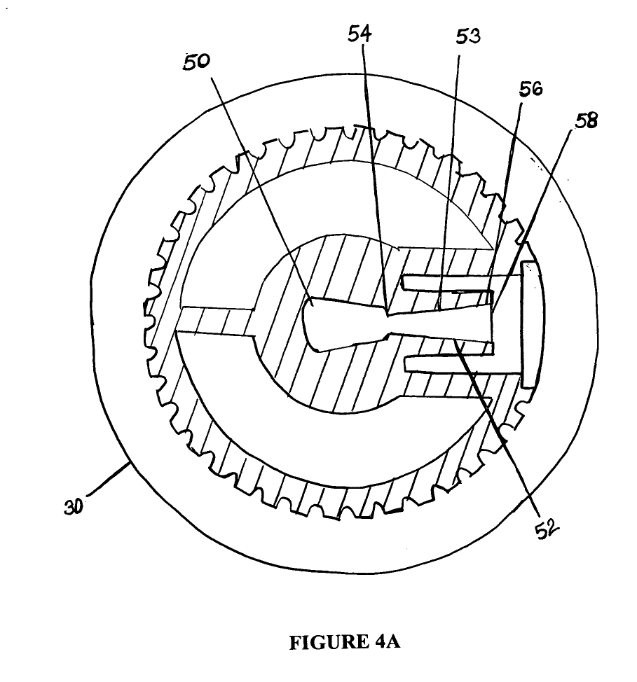

Referring to FIG. 4, a cross-sectional view of the fluid dispensing actuator 30 is provided. The fluid dispensing actuator 30 includes a first passageway 50 configured to connect the fluid dispensing actuator 30 to the downwardly extending stem 46 of the valve member 28. The interior diameter D of a first end 51 of the first circular passageway 50 is sized to securely receive the downwardly extending stem 46 therein, thus securing the fluid dispensing actuator 30 to the valve member 28.

The fluid dispensing actuator 30 includes a second passageway 52 having a first end 54 in fluid communication with the first passageway 50 and a second end 56. The second end 56 of the second passageway 52 forms an output orifice 58. The output orifice 58 is elongated, having a length L greater then its width W. The second passageway 52 includes a transition region 53, expanding to the second passageway 52 from the first end 54 to the second end 56, forming the output orifice.

Referring to FIG. 4A, the transition region is a substantially linear transition region 53 from a substantially circular first end 54 to the second end 56, the elongated output orifice 58. However, it is completed that the transition region 53 can be non linear. For example, the transition region 53 can include arcuate sidewalls, forming an arcuate transition from the first end 54 to the second end 56 of the second passage 52. Alternatively, the transition region 53 can be a step transition region where the second passageway 52 transitions from the first end 54 to the second end 56 utilizing a step pattern, namely a changing of the second passageway's 53 geometry at discrete interval.

Referring also to FIG. 1, the elongated output orifice 58 is depicted on the fluid dispensing actuator 30, where the length L of the elongated output orifice 58 is oriented substantially orthogonal to a longitudinal axis A of the container 20. In this manner, the elongated output orifice 58 dispenses the contents 44 in substantially planar pattern, where the planar pattern is substantially orthogonal to the longitudinal axis A of the container 20.

However, it is contemplated that the orientation of the elongated output orifice 58 on the fluid dispensing actuator 30 can be non-orthogonal to the longitudinal axis A of the container 20. In exemplary embodiments, the length L of the elongated output orifice 58 can be parallel, at an acute angle, or at an obtuse angle with the longitudinal axis A of the container 20. It is further contemplated, that the elongated output orifice 58 can be rotatably connected to the fluid dispensing actuator 30, such that the orientation of the length L of the elongated output orifice 58 with respect to the longitudinal axis A of the container 20 is adjustable.

Alternatively, a nozzle cap can be rotatably connected to the fluid dispensing actuator 30. The nozzle cap can includes a plurality of different nozzle orifices, such that the nozzle cap can be selectively rotated to align a specific orifice with the second end 56 of the second passage 52. The plurality of different nozzle orifice can include different sized, shaped, and oriented orifices.

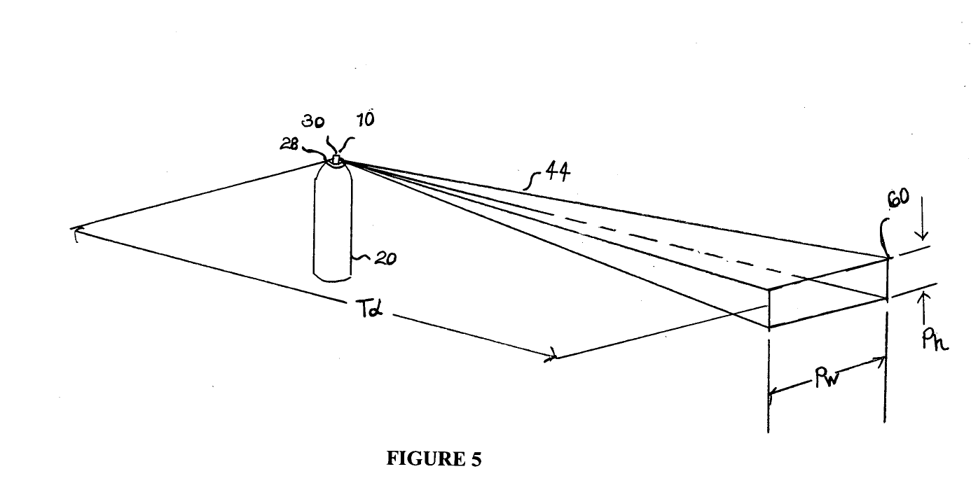

Referring to FIG. 5, in operation when the fire extinguisher 10 is positioned a distance T_{d} from a target area, the elongated output orifice 58 expels the contents 44 of the bag 32 in a substantially planar pattern 60 at the target area, where the planer pattern 60 has a planar width P_{w} greater then the planar height Pₕ.

In an exemplary embodiment, the first end 54 of the second passageway 52 has a diameter of about 0.035 in. +/−0.0010 in. The output orifice 58 has a length L of about 0.075 in. +/−0.010 in. and a width W of about 0.035 in. +/−0.010 in. Where the transition region 53 is substantially linear transition region from the first end 54 of the second circular passageway 52 to the output orifice 58. When the fire extinguisher 10 is positioned a distance T_{d} of about 48 in. from a target area, the elongated output orifice 58 expels the contents 44 is a substantially planar pattern 60 at the target area, having a planar width P_{w} of about 12 in. and a planar height Pₕ of about 3 in.

The contents 44 of the bag 32 is liquid wet chemical fire extinguishing agent formulated to extinguish small fires, such as house hold cooking oil or grease fires, grill fires, electrical fires, automobile file, and the like. As previously discussed, the bag 32 isolates the liquid wet chemical fire extinguishing agent 44 from the propellant 48. In this manner, the propellant 48 is not dispensed with the liquid wet chemical fire extinguishing agent 44, which reduces instance of “flare up” upon an initial application of the liquid wet chemical fire extinguishing spray 44 on a fire.

### Example 1

The liquid wet chemical fire extinguishing agent 44 includes the following ingredients:

| | |
|---|---|
| CH₃CHOHCO₂H (Lactic Acid) | 17-43 vol. % |
| KOH (Potassium Hydroxide) | 18-48 vol. % |
| H₂O | Balance of volume |

### Example 2

The liquid wet chemical fire extinguishing spray 44 includes the following ingredients:

| | |
|---|---|
| CH₃CHOHCO₂H (Lactic Acid) | 17-43 vol. % |
| KOH (Potassium Hydroxide) | 18-48 vol. % |
| K2CO3 (Potassium Carbonate) | 0-23 vol. % |
| KHCO3 (Potassium Bicarbonate) | 0-23 vol. % |
| H₂O | Balance of volume |

### Example 3

The liquid wet chemical fire extinguishing agent 44 includes the following ingredients:

| | |
|---|---|
| CH₃CHOHCO₂H (Lactic Acid) | 27.892 vol. % |
| KOH (Potassium Hydroxide) | 33.687 vol. % |
| K2CO3 (Potassium Carbonate) | 7.366 vol. % |
| KHCO3 (Potassium Bicarbonate) | 3.925 vol. % |
| H₂O | Balance of volume |

### Example 4

The liquid wet chemical fire extinguishing agent 44 includes the following ingredients:

| | |
|---|---|
| CH₃CHOHCO₂H (Lactic Acid) | 28.11 vol. % |
| KOH (Potassium Hydroxide) | 33.56 vol. % |
| K2CO3 (Potassium Carbonate) | 7.55 vol. % |
| KHCO3 (Potassium Bicarbonate) | 21.54 vol. % |
| H₂O | Balance of volume |

In a further embodiment, the liquid wet chemical fire extinguishing agent 44 can include a foaming agent formed of an aqueous solution including a surfactant. The surfactant can be a detergent or other known commercial foam producer. Additional surfactants are disclosed in U.S. Pat. Nos. 4,359,096; 4,536,318; 4,599,188; and 4,565,647 the contents of which are incorporated by reference in their entirety.

### Example 5

The liquid wet chemical fire extinguishing agent 44 with foaming agent includes the following ingredients:

| | |
|---|---|
| CH₃CHOHCO₂H (Lactic Acid) | 17-43 vol. % |
| KOH (Potassium Hydroxide) | 18-48 vol. % |
| Fire Extinguishing Foam | 0-22 vol. % |
| H₂O | Balance of volume |

### Example 6

The liquid wet chemical fire extinguishing spray 44 with foaming agent includes the following ingredients:

| | |
|---|---|
| CH₃CHOHCO₂H (Lactic Acid) | 17-43 vol. % |
| KOH (Potassium Hydroxide) | 18-48 vol. % |
| K2CO3 (Potassium Carbonate) | 0-23 vol. % |
| KHCO3 (Potassium Bicarbonate) | 0-23 vol. % |
| Fire Extinguishing Foam | 0-22 vol. % |
| H₂O | Balance of volume |

### Example 7

The liquid wet chemical fire extinguishing agent 44 with foaming agent includes the following ingredients:

| | |
|---|---|
| CH₃CHOHCO₂H (Lactic Acid) | 27.892 vol. % |
| KOH (Potassium Hydroxide) | 33.687 vol. % |
| K2CO3 (Potassium Carbonate) | 7.366 vol. % |
| KHCO3 (Potassium Bicarbonate) | 3.925 vol. % |
| Fire Extinguishing Foam | 6.927 vol. % |
| H₂O | Balance of volume |

### Example 8

The liquid wet chemical fire extinguishing agent 44 with foaming agent includes the following ingredients:

| | |
|---|---|
| CH₃CHOHCO₂H (Lactic Acid) | 28.11 vol. % |
| KOH (Potassium Hydroxide) | 33.56 vol. % |
| K2CO3 (Potassium Carbonate) | 7.55 vol. % |
| KHCO3 (Potassium Bicarbonate) | 21.54 vol. % |
| Fire Extinguishing Foam | 6.71 vol. % |
| H₂O | Balance of volume |

The Fire Extinguishing Foam agent can include the following ingredient:

| | |
|---|---|
| H₂O | 95-99 vol. % |
| Surfactant | 1-5 vol. % |

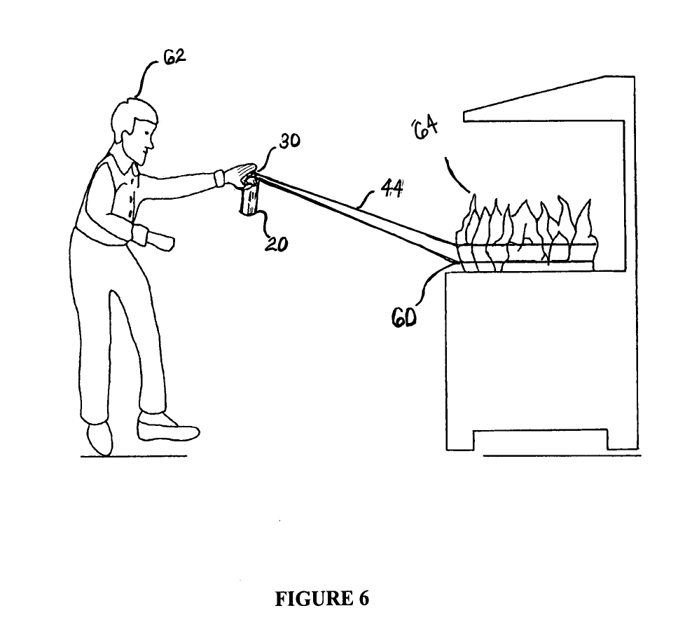

Referring to FIG. 6, in a method of use the fire extinguisher 10 is used to extinguish a kitchen cooking fire. The user 62 holds the container 20 in one hand, directing the output orifice 58 of the fluid dispensing actuator 30 toward the fire. The user depresses the fluid dispensing actuator 30, opening the valve member 28 to dispense the liquid wet chemical fire extinguishing agent 44 onto the fire through the output orifice 58. The liquid wet chemical fire extinguishing agent 44 is expelled in a substantially planar pattern 60 directed at the fire 64. As the liquid wet chemical fire extinguishing agent 44 and the propellant 48 are isolated, only the liquid wet chemical fire extinguishing agent 44 is dispensed into the fire, thus reducing the change of a flare up.

The container 20, bag 32, and fluid dispensing actuator 30 combination provide the additional benefit of having an increased discharge time when compared to small volume extinguishers. For example, a small volume dry chemical fire extinguisher, such as a 1 lb. 2B:C or 5B:C fire extinguisher, has a discharge time of about eight seconds. In contrast, where fire extinguisher 10 is sized to contain fourteen fluid ounces (14 fl oz) of the liquid wet chemical fire extinguishing agent 44, the fire extinguisher 10 has a discharge time of about thirty-two seconds, roughly four (4) times that of the small volume extinguishers.

Similarly, a large volume fire extinguisher, such as a 5 lb. 3A 40B:C fire extinguisher has a discharge time of about thirteen seconds. In contrast, where fire extinguisher 10 is sized to contain fourteen fluid ounces (14 fl oz) of the liquid wet chemical fire extinguishing agent 44, the fire extinguisher 10 has a discharge time of about thirty-two seconds, roughly two and a half (2.5) times that of the large volume extinguisher.

All references cited herein are expressly incorporated by reference in their entirety.

It will be appreciated by persons skilled in the art that the present disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A fire extinguisher comprising:
a container;
a valve assembly affixed to the container;
a actuator connected in fluid communication to the valve assembly, the actuator having an elongated output orifice;
a liquid wet chemical fire extinguishing agent disposed within the container; and
a propellant disposed within the container.

2. A fire extinguisher as set forth in claim 1, wherein the container defines a longitudinal axis, and the elongated output orifice is substantially orthogonal to the longitudinal axis.

3. A fire extinguisher as set forth in claim 1, wherein the actuator expels the liquid wet chemical fire extinguishing agent in a substantially planar pattern.

4. A fire extinguisher as set forth in claim 1, further comprising a bag positionable within the container, the bag connected in fluid communication to the valve assembly opposite the actuator, wherein the liquid wet chemical fire extinguishing agent is disposed within the bag, isolating the liquid wet chemical fire extinguishing agent from the propellant.

5. A fire extinguisher as set forth in claim 1, the liquid wet chemical fire extinguishing agent comprising:
CH₃CHOHCO₂H (Lactic Acid);
KOH (Potassium Hydroxide); and
H₂O.

6. A fire extinguisher as set forth in claim 5, wherein the liquid wet chemical fire extinguishing agent comprises:
about 17-43 vol. % of CH₃CHOHCO₂H (Lactic Acid);
about 18-48 vol. % of KOH (Potassium Hydroxide); and
H₂O.

7. A fire extinguisher as set forth in claim 5, the liquid wet chemical fire extinguishing agent further comprising a fire extinguishing foam.

8. A fire extinguisher as set forth in claim 1, the liquid wet chemical fire extinguishing agent comprising:
about 17-43 vol. % of CH₃CHOHCO₂H (Lactic Acid);
about 18-48 vol. % of KOH (Potassium Hydroxide);
about 0-23 vol. % of K2CO3 (Potassium Carbonate);
about 0-23 vol. % of KHCO3 (Potassium Bicarbonate); and
H₂O.

9. A fire extinguisher as set forth in claim 8, wherein the liquid wet chemical fire extinguishing spray comprises:
about 28 vol. % of CH₃CHOHCO₂H (Lactic Acid);
about 37 vol. % of KOH (Potassium Hydroxide);
about 7 vol. % of K2CO3 (Potassium Carbonate);
about 21 vol. % of KHCO3 (Potassium Bicarbonate); and
H₂O.

10. A fire extinguisher as set forth in claim 8, the liquid wet chemical fire extinguishing agent further comprising a fire extinguishing foam.

11. A liquid wet chemical fire extinguishing agent for an aerosol fire extinguisher, comprising:
CH₃CHOHCO₂H (Lactic Acid);
KOH (Potassium Hydroxide); and
H₂O.

12. A liquid wet chemical fire extinguishing agent for an aerosol fire extinguisher as set forth in claim 11, wherein the liquid wet chemical fire extinguishing agent includes:
about 17-43 vol. % of CH₃CHOHCO₂H (Lactic Acid); and
about 18-48 vol. % of KOH (Potassium Hydroxide).

13. A liquid wet chemical fire extinguishing agent for an aerosol fire extinguisher as set forth in claim 11, further comprising a fire extinguishing foam.

14. A liquid wet chemical fire extinguishing agent for an aerosol fire extinguisher as set forth in claim 11, further comprising:
K2CO3 (Potassium Carbonate); and
KHCO3 (Potassium Bicarbonate).

15. A liquid wet chemical fire extinguishing agent for an aerosol fire extinguisher as set forth in claim 14, wherein the liquid wet chemical fire extinguishing agent includes:
about 17-43 vol. % of CH₃CHOHCO₂H (Lactic Acid);
about 18-48 vol. % of KOH (Potassium Hydroxide);
about 0-23 vol. % of K2CO3 (Potassium Carbonate);
about 0-23 vol. % of KHCO3 (Potassium Bicarbonate); and
H₂O.

16. A liquid wet chemical fire extinguishing agent for an aerosol fire extinguisher as set forth in claim 15, wherein the liquid wet chemical fire extinguishing agent includes:
about 28 vol. % of CH₃CHOHCO₂H (Lactic Acid);
about 37 vol. % of KOH (Potassium Hydroxide);
about 7 vol. % of K2CO3 (Potassium Carbonate);
about 21 vol. % of KHCO3 (Potassium Bicarbonate); and
H₂O.

17. A liquid wet chemical fire extinguishing agent for an aerosol fire extinguisher as set forth in claim 14, further comprising a fire extinguishing foam.

18. A method for extinguishing a fire, comprising:
providing a fire extinguisher including a container, a valve assembly affixed to the container, a actuator connected in fluid communication to the valve assembly and having an elongated output orifice, a liquid wet chemical fire extinguishing agent disposed within the container, and a propellant disposed within the container;
directing the elongated orifice at the fire;
depressing the actuator to open the valve assembly; and
expelling the liquid wet chemical fire extinguishing agent onto the fire in a substantially planar pattern.

19. A method for extinguishing a fire as set forth in claim 18, wherein the container defines a longitudinal axis, and the elongated output orifice is substantially orthogonal to the longitudinal axis.

20. A method for extinguishing a fire as set forth in claim 18, wherein the liquid wet chemical fire extinguishing agent includes:
CH₃CHOHCO₂H (Lactic Acid);
KOH (Potassium Hydroxide); and
H₂O.

21. A fire extinguisher comprising:
a container defining a longitudinal axis;
a valve assembly affixed to the container;
a actuator connected in fluid communication to the valve assembly, the actuator including an elongated output orifice, wherein the elongated output orifice is substantially orthogonal to the longitudinal axis;
a liquid wet chemical fire extinguishing agent disposed within the container; and
a propellant disposed within the container.
